(19) United States
(12) Patent Application Publication
(10) Pub. No.: US 2026/0070088 A1
(43) Pub. Date: Mar. 12, 2026

(54) VIBRATION DEVICE

(71) Applicant: Murata Manufacturing Co., Ltd., Nagaokakyo-shi (JP)

(72) Inventors: Hitoshi SAKAGUCHI, Nagaokakyo-shi (JP); Yuuki ISHII, Nagaokakyo-shi (JP); Yuka TANAKA, Nagaokakyo-shi (JP)

(21) Appl. No.: 19/393,962

(22) Filed: Nov. 19, 2025

Related U.S. Application Data
(63) Continuation of application No. PCT/JP2024/000373, filed on Jan. 11, 2024.

(30) Foreign Application Priority Data
Jun. 7, 2023 (JP) 2023-094342

(51) Int. Cl. B06B 1/06

(52) U.S. Cl. CPC B06B 1/0651

(57) ABSTRACT

A vibration device that includes: a vibration body; a piezoelectric element at a first end of the vibration body in a first direction; and a translucent body that has an optical axis extending in the first direction and at a second end of the vibration body in the first direction. The vibration body includes a first flange portion connected to the translucent body, a second flange portion connected to the piezoelectric element, and an arm portion that connects the first flange portion to the second flange portion. In a cross-section including the optical axis, the first flange portion and the second flange portion extend from a position separate from the optical axis in a second direction intersecting the first direction in a direction towards to the optical axis. The arm portion has a curved shape in the cross-section including the optical axis.

### CROSS REFERENCE TO RELATED APPLICATIONS

The present application is a continuation of International application No. PCT/JP2024/000373, filed January 11, 2024, which claims priority to Japanese Patent Application No. 2023-094342, filed June 7, 2023, the entire contents of each of which are incorporated herein by reference.

### TECHNICAL FIELD

The present disclosure relates to a vibration device.

### BACKGROUND ART

Patent Document 1 discloses a vibration device including a vibrator having a cylindrical vibration body on which a translucent body is disposed, a support body that supports the vibration body, and a connection member that connects the vibration body to the support body.

Patent Document 1: Japanese Patent No. 7010386

### SUMMARY OF THE DISCLOSURE

In the vibration device of Patent Document 1, there is room for improvement in terms of reducing the stress applied to the translucent body while preventing foreign matter adhering to the translucent body from being deposited on the vibration body.

The present disclosure intends to provide a vibration device that can reduce the stress applied to a translucent body while preventing foreign matter adhering to the translucent body from depositing on a vibration body.

A vibration device of an aspect of the present disclosure includes: a vibration body; a piezoelectric element at a first end of the vibration body in a first direction; and a translucent body that has an optical axis extending in the first direction and at a second end of the vibration body in the first direction, wherein the vibration body includes: a first flange portion connected to the translucent body, a second flange portion connected to the piezoelectric element, and an arm portion that connects the first flange portion to the second flange portion, in a cross-section including the optical axis, the first flange portion and the second flange portion extend from a position separate from the optical axis in a second direction intersecting the first direction in a direction towards the optical axis, and the arm portion has a curved shape in the cross-section.

With the vibration device of the above-described aspect, the stress applied to the translucent body can be reduced while foreign matter adhering to the translucent body is prevented from depositing on the vibration body.

### BRIEF DESCRIPTION OF THE DRAWINGS

FIG. 1 is a perspective view depicting a vibration device of an embodiment of the present disclosure.

FIG. 2 is a sectional view along line II-II in FIG. 1.

FIG. 3 is a diagram depicting a simulation result of displacement amount distribution in the vibration device of FIG. 1.

FIG. 4 is a diagram depicting a simulation result of stress distribution in the vibration device of FIG. 1.

FIG. 5 is a sectional view depicting an example of a vibration device that does not include a vibration body of the vibration device of FIG. 1.

FIG. 6 is a diagram depicting a simulation result of displacement amount distribution in the vibration device of FIG. 5.

FIG. 7 is a diagram depicting a simulation result of stress distribution in the vibration device of FIG. 5.

FIG. 8 is a graph in which the stress applied to a joining portion between a lens and the vibration body of the vibration device of FIG. 1 is compared with the stress applied to a joining portion between a lens and a vibration body of the vibration device of FIG. 5.

FIG. 9 is a perspective view depicting an example of usage of the vibration device of FIG. 1.

FIG. 10 is a perspective view depicting an example of usage of the vibration device of FIG. 5.

FIG. 11 is a graph indicating a relationship between the ratio of a first distance to a second distance and the stress applied to the joining portion between the lens and a first flange portion.

### DESCRIPTION OF THE PREFERRED EMBODIMENTS

Various aspects of the present disclosure are described.

A vibration device of a first aspect of the present disclosure includes: a vibration body; a piezoelectric element at a first end of the vibration body in a first direction; and a translucent body that has an optical axis extending in the first direction and is at a second end of the vibration body in the first direction, wherein the vibration body includes: a first flange portion connected to the translucent body, a second flange portion connected to the piezoelectric element, and an arm portion that connects the first flange portion to the second flange portion, in a cross-section including the optical axis, the first flange portion and the second flange portion extend from a position separate from the optical axis in a second direction intersecting the first direction in a direction towards to the optical axis, and the arm portion has a curved shape in the cross-section.

With the vibration device of the first aspect, the separation stress applied to the joining portion between the translucent body and the vibration body can be greatly reduced. Thus, the stress applied to the translucent body during vibration of the vibration body can be reduced, and deterioration of optical characteristics can be suppressed. Deposition of foreign matter such as rain droplets and muddy water on the vibration body can be suppressed by the curved shape of the arm portion. That is, with the vibration device of the first aspect, the stress applied to the translucent body can be reduced while the foreign matter adhering to the translucent body is prevented from depositing on the vibration body.

A vibration device of a second aspect of the present disclosure is obtained by employing the following configuration in the vibration device of the first aspect: the arm portion includes: a first arm portion that extends from a first end portion of the first flange portion farthest from the optical axis in the second direction toward the second flange portion, and a second arm portion that extends from a third end portion of the second flange portion farthest from the optical axis in the second direction toward the first flange portion and is connected to a second end portion of the first arm portion on an opposite side to the first end portion of the first arm portion.

With the vibration device of the second aspect, the stress applied to the translucent body can be more reliably reduced while the foreign matter adhering to the translucent body is more reliably prevented from depositing on the vibration body.

A vibration device of a third aspect of the present disclosure is obtained by employing the following configuration in the vibration device of the second aspect: when a distance in the first direction from a part in the first flange portion in contact with the translucent body to a connection part of the first arm portion and the second arm portion is defined as a first distance and a total length of the arm portion in the first direction is defined as a second distance, a ratio of the first distance to the second distance is equal to or greater than 0.05.

The vibration device of the third aspect can reduce the stress applied to the translucent body to a larger extent.

A vibration device of a fourth aspect of the present disclosure is obtained by employing the following configuration in the vibration device of any one of the first to third aspects: the vibration device further includes a holding member positioned outside the translucent body in the second direction and constructed to hold the connection between the translucent body and the first flange portion.

The vibration device of the fourth aspect can prevent the translucent body from dropping off the vibration body by the holding member. For example, by forming the holding member that can block light, light incident from a side surface of the translucent body can be blocked, and the occurrence of stray light, ghost, flare, and the like can be reduced.

A vibration device of a fifth aspect of the present disclosure is obtained by employing the following configuration in the vibration device of the fourth aspect: the holding member has asymmetry with respect to the optical axis.

The vibration device of the fifth aspect can cause slip-down of the foreign matter adhering to the translucent body more reliably.

A vibration device of a sixth aspect of the present disclosure is obtained by employing the following configuration in the vibration device of any one of the first to fifth aspects: the cross-section of the first arm portion has a curved shape that protrudes from the first flange portion toward the second flange portion, and the cross-section of the second arm portion has a curved shape that protrudes from the second flange portion toward the first flange portion.

With the vibration device of the sixth aspect, the stress applied to the translucent body can be more reliably reduced while the foreign matter adhering to the translucent body is more reliably prevented from depositing on the vibration body.

A vibration device of a seventh aspect of the present disclosure is obtained by employing the following configuration in the vibration device of the sixth aspect: a radius of curvature of the curved shape of the first arm portion is larger than a radius of curvature of the curved shape of the second arm portion.

With the vibration device of the seventh aspect, the stress applied to the translucent body can be more reliably reduced while the foreign matter adhering to the translucent body is more reliably prevented from depositing on the vibration body.

A vibration device of an eighth aspect of the present disclosure is obtained by employing the following configuration in the vibration device of any one of the first to seventh aspects: the arm portion extends along the optical axis.

With the vibration device of the eighth aspect, the stress applied to the translucent body can be more reliably reduced while the foreign matter adhering to the translucent body is more reliably prevented from depositing on the vibration body.

A vibration device of a ninth aspect of the present disclosure is obtained by employing the following configuration in the vibration device of any one of the first to eighth aspects: a thickness of the second flange portion is larger than a thickness of the first flange portion.

The vibration device of the ninth aspect can efficiently transmit the vibration of the piezoelectric element to the translucent body.

An embodiment of the present disclosure is described below with reference to the drawings. The following description does not limit the present disclosure and is merely an example essentially, and can be changed as appropriate without departing from the gist of the present disclosure. The drawings are schematic ones, and the ratio of the respective dimensions and the like do not necessarily correspond with actual ones.

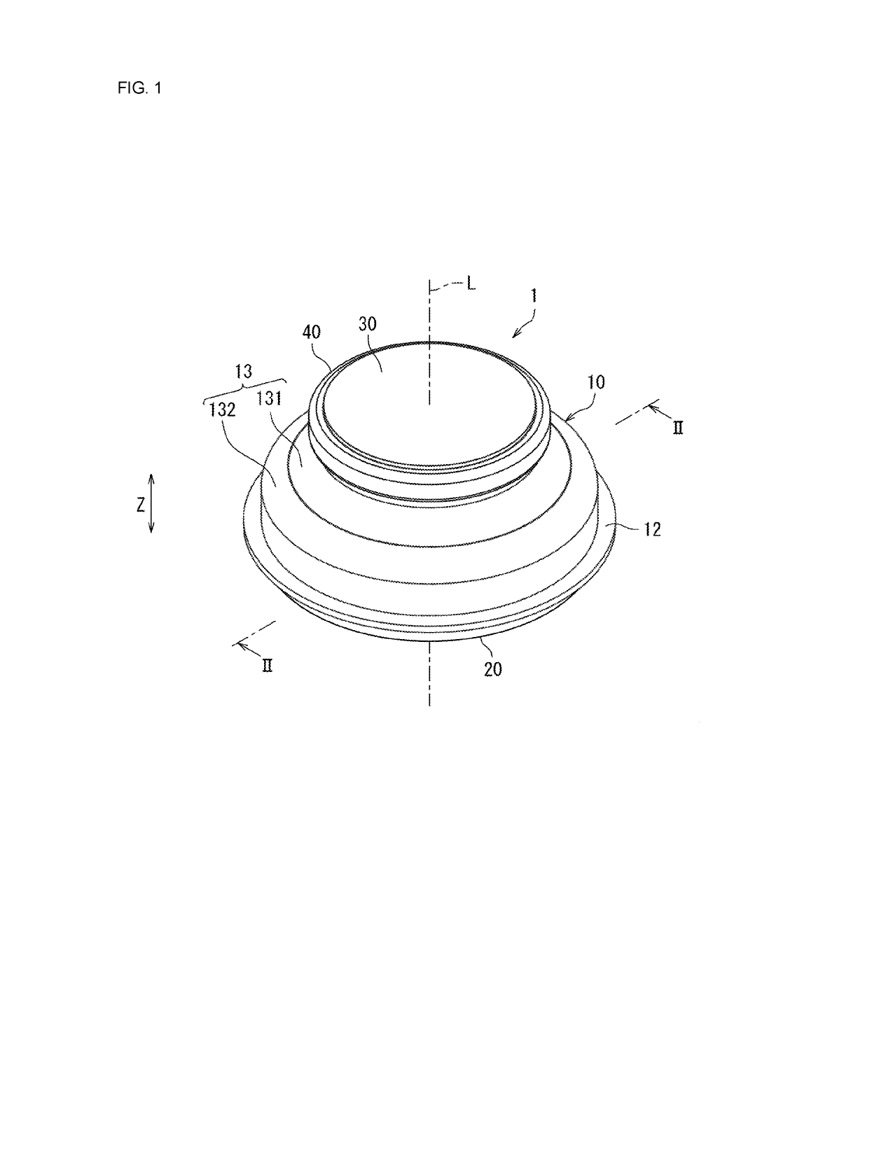

As depicted in FIG. 1, a vibration device 1 of an embodiment of the present disclosure includes a vibration body 10, a piezoelectric element 20 located at one end of the vibration body 10 in a first direction (for example, Z-direction), and a lens 30 (an example of the translucent body) located at the other end of the vibration body 10 in the first direction Z. The lens 30 has an optical axis L extending in the first direction Z.

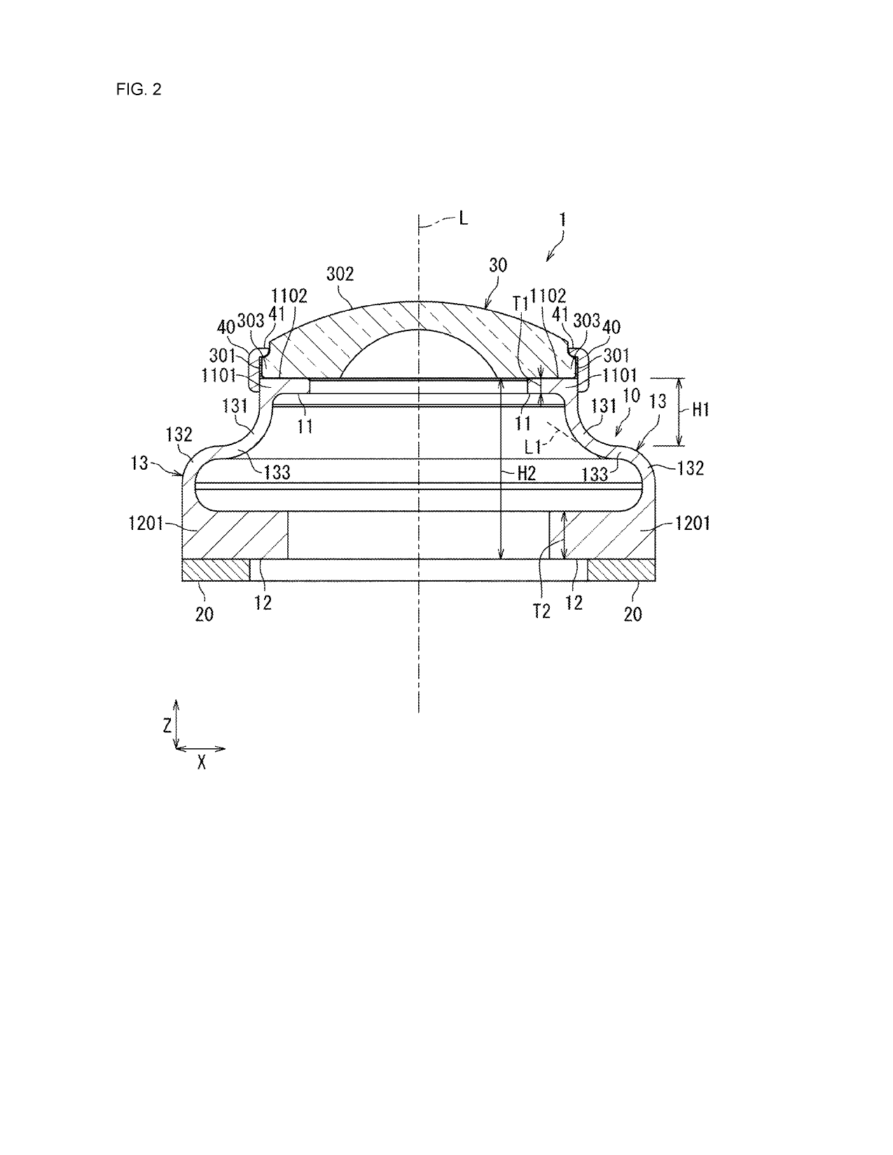

The vibration body 10 has a substantially circular cylindrical shape as an example, and is configured to amplify vibration from the piezoelectric element 20 to allow the lens 30 to vibrate. In the present embodiment, as depicted in FIG. 2, the vibration body 10 includes a first flange portion 11 connected to the lens 30, a second flange portion 12 connected to the piezoelectric element 20, and an arm portion 13 that connects the first flange portion 11 to the second flange portion 12.

As depicted in FIG. 2, in a cross-section including the optical axis L, the first flange portion 11 and the second flange portion 12 extend from a position separate from the optical axis L in a second direction X (for example, X-direction) intersecting the first direction Z in a direction that is towards the optical axis L. In the present embodiment, the first flange portion 11 and the second flange portion 12 have a substantially circular annular shape extending in the circumferential direction around the optical axis L. The second direction X is an example of a radial direction around the optical axis L. The first flange portion 11 extends in the second direction X from an end 301 of the lens 30 in the second direction X toward the optical axis L. The second flange portion 12 extends in the second direction X from a position that is farther from the optical axis L than the end 301 of the lens 30 in the second direction X toward the optical axis L.

The arm portion 13 has a curved shape in the cross-section including the optical axis L. In the present embodiment, the arm portion 13 includes a first arm portion 131 and a second arm portion 132. The arm portion 13 extends along the optical axis L, and has a substantially S-shape in the cross-section including the optical axis L. The radius of curvature of the curved shape of the first arm portion 131 is larger than that of the curved shape of the second arm portion 132.

In the cross-section including the optical axis L, the first arm portion 131 extends from an end portion 1101 farther from the optical axis L, of both ends of the first flange portion 11 in the second direction X, toward the second flange portion 12. A cross-section of the first arm portion 131 including the optical axis L has a curved shape that protrudes from the first flange portion 11 toward the second flange portion 12.

The second arm portion 132 extends from an end portion 1201 farther from the optical axis L, of both ends of the second flange portion 12 in the second direction X, toward the first flange portion 11, and is connected to an end portion of the first arm portion 131 on the opposite side to an end portion connected to the first flange portion 11 in the first arm portion 131. A cross-section of the second arm portion 132 including the optical axis L has a curved shape that protrudes from the second flange portion 12 toward the first flange portion 11.

In the present embodiment, the first arm portion 131 and the second arm portion 132 are connected at a part at which a tangent line L1 to an outer shape line of the arm portion 13 in the cross-section including the optical axis L extends in the second direction X. That is, the tangent line L1 extends substantially in parallel to the second direction X at a connection part 133 of the first arm portion 131 and the second arm portion 132. The vibration body 10 is configured such that a thickness T2 of the second flange portion 12 is larger than a thickness T1 of the first flange portion 11. The thicknesses T1 and T2 of the first flange portion 11 and the second flange portion 12 are, for example, average values of the dimensions of the first flange portion 11 and the second flange portion 12 in the first direction Z.

The piezoelectric element 20 has a piezoelectric body and electrodes, and is configured to be capable of generating vibration. The piezoelectric body is composed of, for example, appropriate piezoelectric ceramics such as barium titanate (BaTiO₃), lead zirconate titanate (PZT: PbTiO₃·PbZrO₃), lead titanate (PbTiO₃), lead metaniobate (PbNb₂O₆), bismuth titanate (Bi₄Ti₃O₁₂), or (K,Na)NbO₃ or an appropriate piezoelectric single crystal such as LiTaO₃ or LiNbO₃. The electrodes are composed of, for example, Ni, Ag, or Au.

In the present embodiment, the piezoelectric element 20 has a substantially circular annular shape extending in the circumferential direction around the optical axis L, and is located symmetrically with respect to the optical axis L. The piezoelectric element 20 is connected to the second flange portion 12 by, for example, an adhesive.

As an example, the lens 30 is composed of glass, and has a substantially circular shape as viewed in the first direction Z. The lens 30 curves to protrude in a direction away from the vibration body 10 in the first direction Z. A surface 302 of the lens 30 is coated with a water-repellent coat and an antireflection film (AR coat). A protruding portion 303 that protrudes outward in the radial direction around the optical axis L is provided at the end 301 of the lens 30 in the second direction X.

In the present embodiment, the vibration device 1 includes a holding member 40. The holding member 40 is located outside the lens 30 in the second direction X, and is configured to hold the connection between the lens 30 and the first flange portion 11. As an example, the holding member 40 has a substantially circular annular shape extending along an edge portion of the lens 30 as viewed in the first direction Z. The holding member 40 extends from the lens 30 to the first flange portion 11 in the first direction Z in the cross-section including the optical axis L. The connection part of the lens 30 and the first flange portion 11 is covered by the holding member 40.

A fastening portion 41 is provided at an end portion farther from the first flange portion 11, of both ends of the holding member 40 in the first direction Z. The fastening portion 41 protrudes from the holding member 40 toward the lens 30. The protruding portion 303 of the lens 30 is located between the fastening portion 41 and the first flange portion 11 in the first direction Z. This prevents the lens 30 from dropping off the vibration body 10.

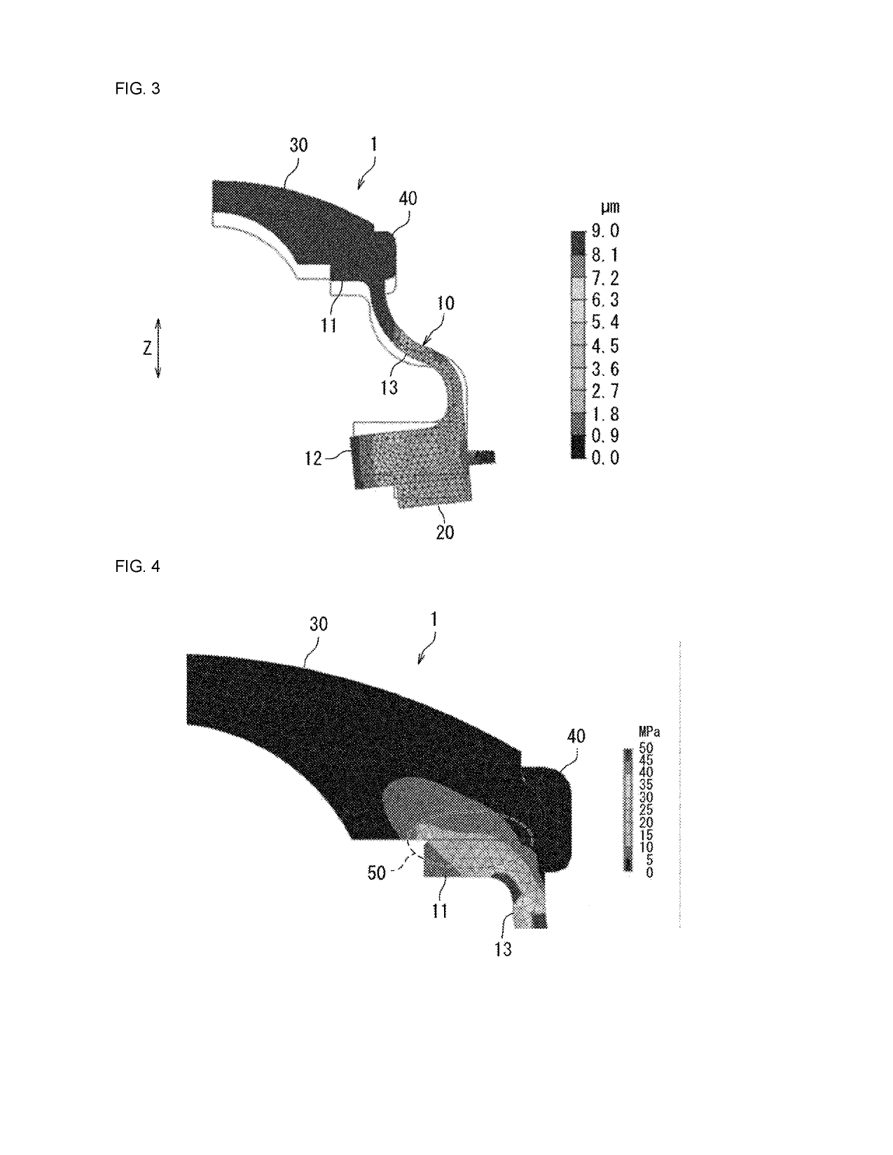

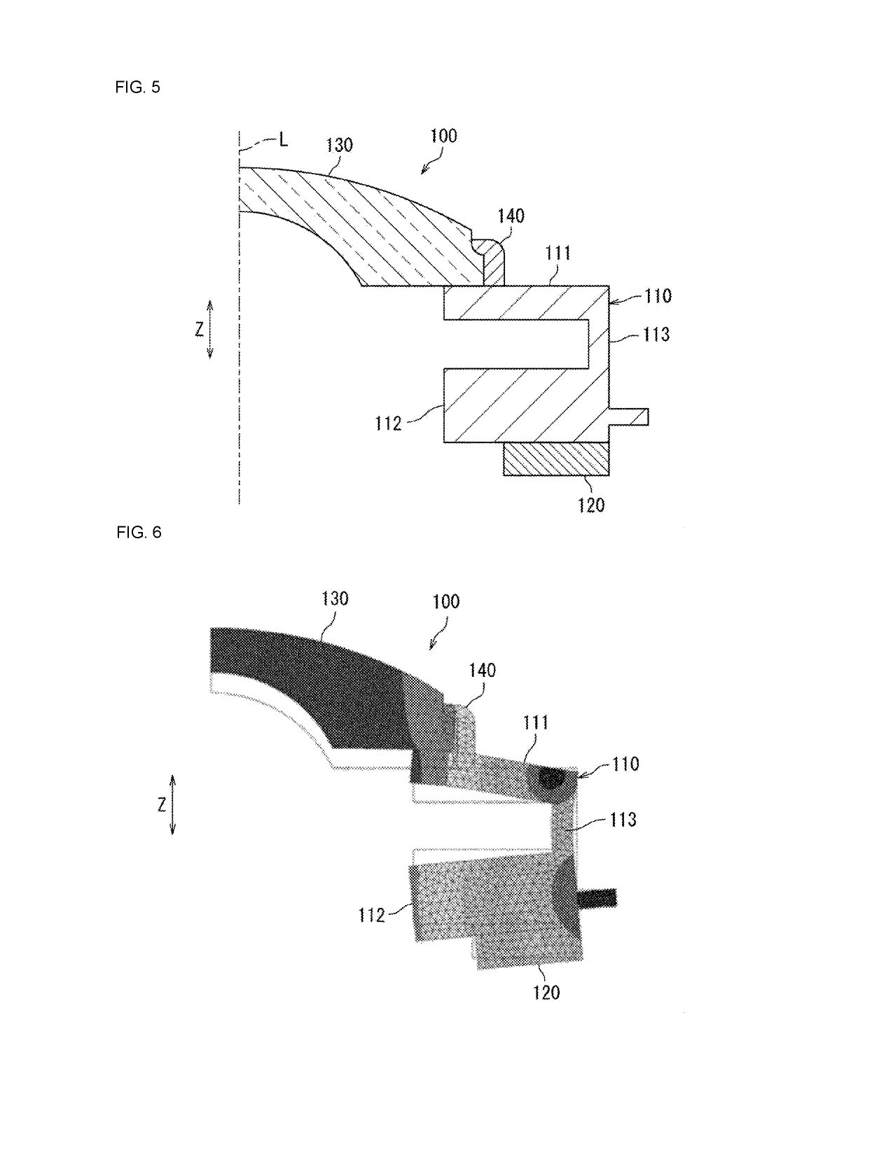

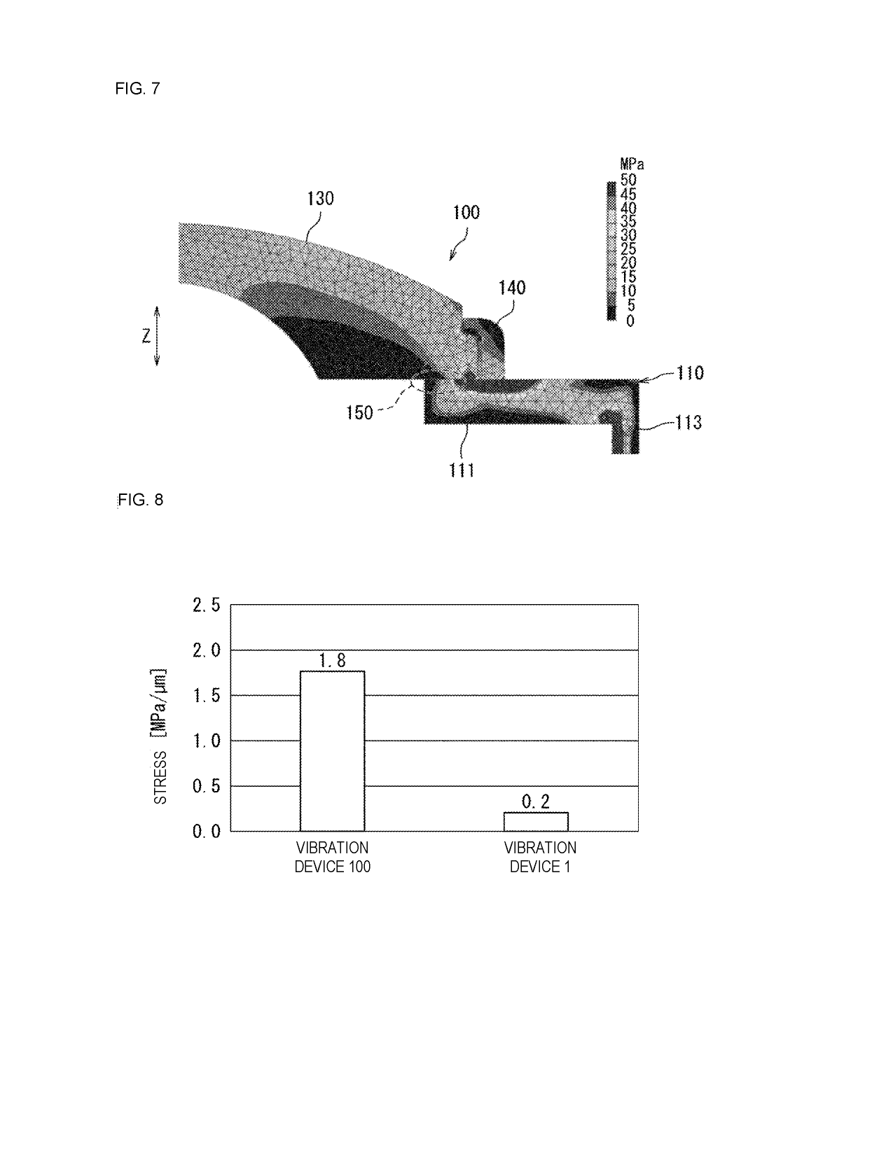

FIG. 3 depicts a simulation result of displacement amount distribution of the vibration device 1 when the piezoelectric element 20 is driven. FIG. 4 depicts a simulation result of stress distribution around a joining portion 50 between the lens 30 and the vibration body 10 of the vibration device 1. FIG. 6 depicts a simulation result of displacement amount distribution of a vibration device 100 (depicted in FIG. 5) that does not include the vibration body 10 when a piezoelectric element 120 is driven. FIG. 7 depicts a simulation result of stress distribution around a joining portion 150 between a lens 130 and a vibration body 110 of the vibration device 100.

The simulation was performed on the basis of the assumption that, in the vibration device 100, the components excluding the vibration body 110, that is, the piezoelectric element 120, the lens 130, and a holding member 140, included the same configuration as those in the vibration device 1. The vibration body 110 includes a first flange portion 111, a second flange portion 112, and a connection portion 113, and does not have a curved shape in a cross-section including the optical axis L. The first flange portion 111 extends in a direction substantially orthogonal to the optical axis L and is connected to the lens 130. The second flange portion 112 extends in a direction substantially orthogonal to the optical axis L and is connected to the piezoelectric element 120. The connection portion 113 linearly extends in the first direction Z in the cross-section including the optical axis L, and connects a part farthest from the optical axis L in the first flange portion 111 to a part farthest from the optical axis L in the second flange portion 112.

As depicted in FIG. 3, in the vibration device 1, the lens 30 moves in an upward-downward direction (that is, first direction Z). That is, in the vibration device 1, displacement in the upward-downward direction is input from the vibration body 10 to the lens 30 due to vibration generated in the piezoelectric element 20. As depicted in FIG. 6, in the vibration device 100, the lens 130 moves in a direction intersecting the upward-downward direction in addition to the upward-downward direction.

As depicted in FIG. 4, in the vibration device 1, a stress is applied to part of the lens 30 around the joining portion 50. As depicted in FIG. 7, in the vibration device 100, a stress is applied to not only the periphery of the joining portion 150 but also a wide range in the lens 130.

FIG. 8 depicts a graph in which the stress applied to the joining portion 50 of the vibration device 1 is compared with the stress applied to the joining portion 150 of the vibration device 100. As depicted in FIG. 8, a stress approximately nine times the stress applied to the joining portion 50 of the vibration device 1 is applied to the joining portion 150 of the vibration device 100. That is, it turns out that the vibration device 1 can greatly reduce the separation stress applied to the joining portion between the lens 30 and the vibration body 10 compared with the vibration device 100.

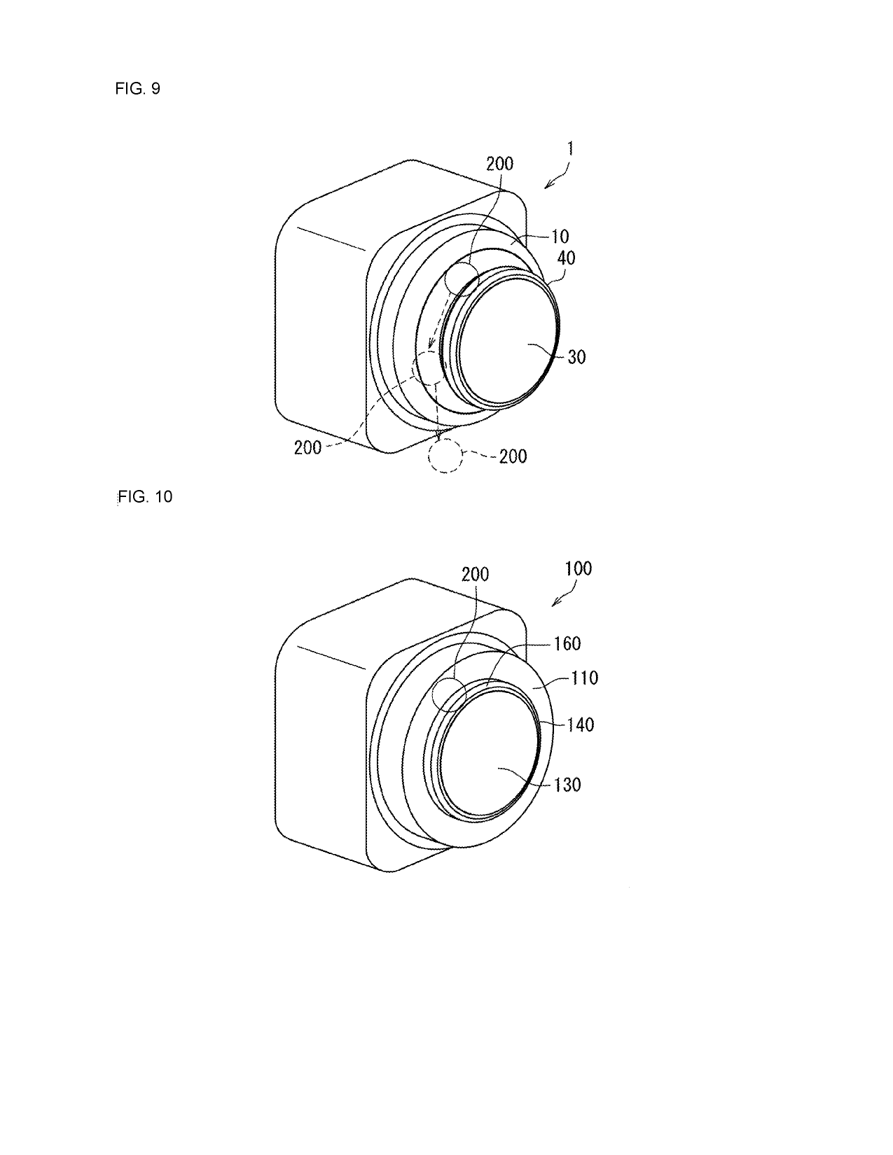

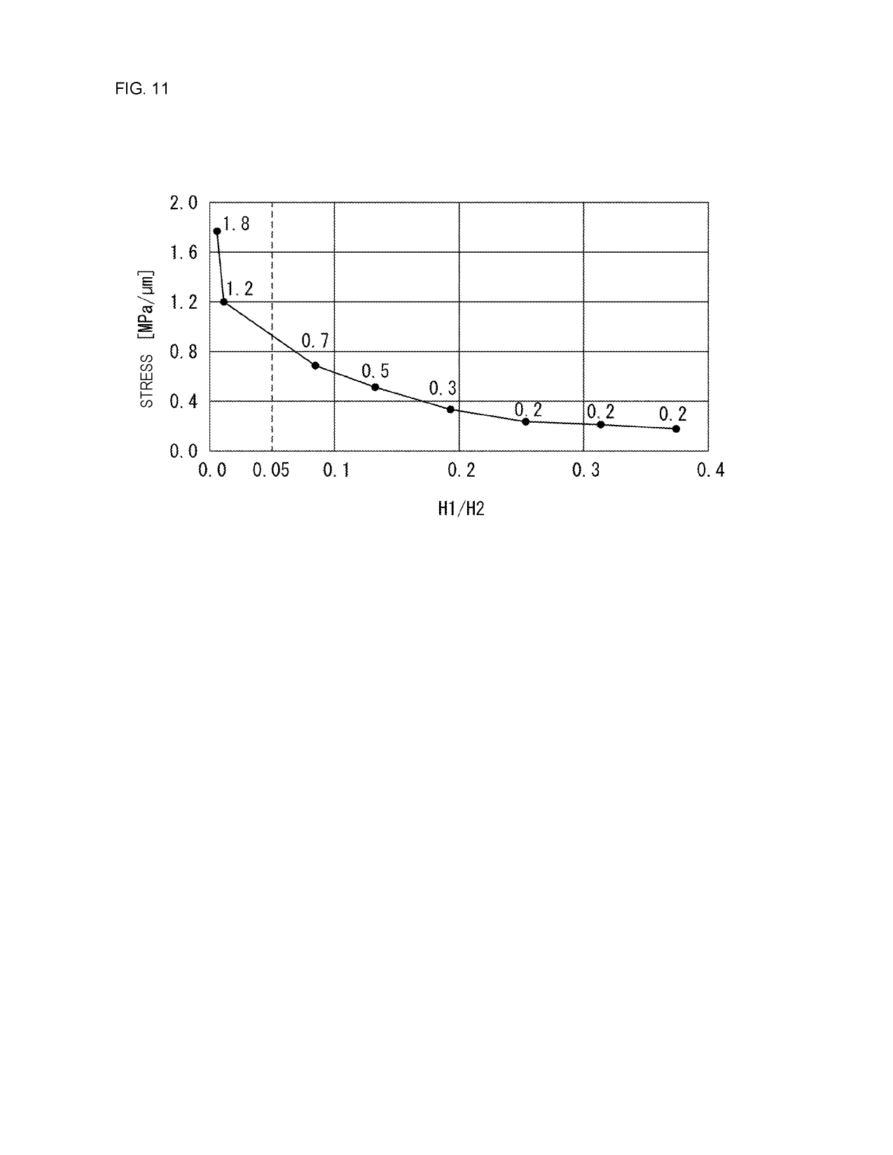

FIG. 9 depicts an example of usage of the vibration device 1. FIG. 10 depicts an example of usage of the vibration device 100. It is assumed that the upward-downward direction is the vertical direction in FIGS. 9 and 10. As depicted in FIG. 9, even when a droplet 200 adheres to the vibration body 10, slip-down of the droplet 200 from the vibration body 10 is promoted by the curved shape of the arm portion 13, and a droplet accumulation is less likely to be formed on the vibration body 10. As depicted in FIG. 10, when the droplet 200 adheres to the vibration device 100, the droplet 200 is trapped by a right-angle portion 160 formed by the holding member 140 and the vibration body 110, and a droplet accumulation is more likely to be formed than with the vibration device 1. That is, the vibration device 1 can suppress deposition of foreign matter such as rain droplets and muddy water on the vibration body 10 compared with the vibration device 100.

The vibration device 1 can provide the following effects.

The vibration device 1 includes the vibration body 10, the piezoelectric element 20 located at one end of the vibration body 10 in the first direction, and the lens 30 that has the optical axis L extending in the first direction and is located at the other end of the vibration body 10 in the first direction. The vibration body 10 includes the first flange portion 11 connected to the lens 30, the second flange portion 12 connected to the piezoelectric element 20, and the arm portion 13 that connects the first flange portion 11 to the second flange portion 12. In a cross-section including the optical axis L, the first flange portion 11 and the second flange portion 12 extend from a position separate from the optical axis L in the second direction intersecting the first direction in a direction that is the second direction and is such a direction as to come closer to the optical axis L. The arm portion 13 has the curved shape in the cross-section including the optical axis L. Due to such a configuration, the separation stress applied to the joining portion between the lens 30 and the vibration body 10 can be greatly reduced. Thus, the stress applied to the lens 30 during vibration of the vibration body 10 can be reduced, and deterioration of optical characteristics can be suppressed. Deposition of foreign matter such as rain droplets and muddy water on the vibration body 10 can be suppressed by the curved shape of the arm portion 13. That is, with the vibration device 1, the stress applied to the lens 30 can be reduced while the foreign matter adhering to the lens 30 is prevented from depositing on the vibration body 10.

The arm portion 13 includes the first arm portion 131 and the second arm portion 132. The first arm portion 131 extends from the end portion 1101 farther from the optical axis L, of both ends of the first flange portion 11 in the second direction X, toward the second flange portion 12. The second arm portion 132 extends from the end portion 1201 farther from the optical axis L, of both ends of the second flange portion 12 in the second direction, toward the first flange portion 11, and is connected to the end portion of the first arm portion 131 on the opposite side to the end portion connected to the first flange portion 11 in the first arm portion 131. Due to such a configuration, the stress applied to the lens 30 can be more reliably reduced while the foreign matter adhering to the lens 30 is more reliably prevented from depositing on the vibration body 10.

The ratio of a first distance H1 to a second distance H2 is equal to or greater than 0.05. Such a configuration can reduce the stress applied to the lens 30 to a larger extent.

The vibration device 1 includes the holding member 40 that is located outside the lens 30 in the second direction. The holding member 40 holds the connection between the lens 30 and the first flange portion 11. Such a configuration can prevent the lens 30 from dropping off the vibration body 10. For example, by forming the holding member 40 that can block light, light incident from a side surface of the lens 30 can be blocked, and the occurrence of stray light, ghost, flare, and the like can be reduced.

The cross-section of the first arm portion 131 including the optical axis L has the curved shape that protrudes from the first flange portion 11 toward the second flange portion 12. The cross-section of the second arm portion 132 including the optical axis L has the curved shape that protrudes from the second flange portion 12 toward the first flange portion 11. Due to such a configuration, the stress applied to the lens 30 can be more reliably reduced while the foreign matter adhering to the lens 30 is more reliably prevented from depositing on the vibration body 10.

The radius of curvature of the curved shape of the first arm portion 131 is larger than that of the curved shape of the second arm portion 132. Due to such a configuration, the stress applied to the lens 30 can be more reliably reduced while the foreign matter adhering to the lens 30 is more reliably prevented from depositing on the vibration body 10.

The arm portion 13 extends along the optical axis L. Due to such a configuration, the stress applied to the lens 30 can be more reliably reduced while the foreign matter adhering to the lens 30 is more reliably prevented from depositing on the vibration body 10.

The thickness T2 of the second flange portion 12 is larger than the thickness T1 of the first flange portion 11. Such a configuration can efficiently transmit the vibration of the piezoelectric element 20 to the lens 30.

It is also possible to configure the vibration device 1 as follows.

A distance in the first direction Z from a part 1102 in the first flange portion 11 in contact with the lens 30 to the connection part 133 of the first arm portion 131 and the second arm portion 132 is defined as a first distance H1 (see FIG. 2). The total length of the arm portion 13 in the first direction Z is defined as a second distance H2 (see FIG. 2). The vibration body 10 may be configured such that the ratio of the first distance H1 to the second distance H2 is equal to or greater than 0.05 (H1/H2 ≥ 0.05).

FIG. 11 indicates a relationship between the ratio of the first distance H1 to the second distance H2 and the stress applied to the joining portion between the lens 30 and the first flange portion 11. As depicted in FIG. 11, the stress applied to the joining portion between the lens 30 and the first flange portion 11 becomes higher as the ratio of the first distance H1 to the second distance H2 becomes lower. By forming the vibration body 10 such that H1/H2 ≥ 0.05 is satisfied, the stress applied to the joining portion between the lens 30 and the first flange portion 11 is reduced to approximately 1/2 or lower of the stress applied to the joining portion between the lens 130 and the vibration body 110 of the vibration device 100 depicted in FIG. 5. That is, the stress applied to the lens 30 can be reduced to a larger extent by forming the vibration body 10 such that H1/H2 ≥ 0.05 is satisfied.

The holding member 40 may be configured to have asymmetry with respect to the optical axis L. Such a configuration can more reliably prevent the foreign matter adhering to the lens 30 from depositing on the vibration body 10. The asymmetry can be implemented by, for example, forming the holding member 40 by a plurality of materials or disposing a plurality of regions different in the Young's modulus, the density, or the mechanical Q factor in the holding member 40.

The cross-section of the arm portion 13 including the optical axis L is only required to have the curved shape, and is not limited to the above-described embodiment. For example, the cross-section of the first arm portion 131 including the optical axis L is not required to have the curved shape that protrudes from the first flange portion 11 toward the second flange portion 12. The cross-section of the second arm portion 132 including the optical axis L is not required to have the curved shape that protrudes from the second flange portion 12 toward the first flange portion 11. The radius of curvature of the curved shape of the first arm portion 131 is not required to be larger than that of the curved shape of the second arm portion 132. The arm portion 13 is not required to extend along the optical axis L.

In the present disclosure, any embodiments and/or modifications among the above-described various embodiments and modifications can be combined as appropriate. In combinations of embodiments and/or modifications, combinations of configurations included in the embodiments and/or configurations included in examples are also included.

Although the present disclosure is sufficiently described through the above-described embodiments and/or modifications with reference to the accompanying drawings, the above-described embodiments and/or modifications do not cover the whole of the present disclosure. Those skilled in the art in the technical field of the present disclosure can make many corrections and modifications. It should be understood that such modifications and corrections are included in the present disclosure as long as the modifications and the corrections are not out of the scope of the present disclosure.

### Reference Signs List

1 vibration device

10 vibration body

11 first flange portion

12 second flange portion

13 arm portion

20 piezoelectric element

30 lens

40 holding member

41 fastening portion

50 joining portion

100 vibration device

110 vibration body

111 first flange portion

112 second flange portion

113 connection portion

120 piezoelectric element

130 lens

131 first arm portion

132 second arm portion

133 connection part

140 holding member

150 joining portion

160 right-angle portion

200 droplet

1. A vibration device comprising:
a vibration body;
a piezoelectric element at a first end of the vibration body in a first direction; and
a translucent body that has an optical axis extending in the first direction and is at a second end of the vibration body in the first direction, wherein
the vibration body includes:
a first flange portion connected to the translucent body,
a second flange portion connected to the piezoelectric element, and
an arm portion that connects the first flange portion to the second flange portion, wherein
in a cross-section including the optical axis, the first flange portion and the second flange portion extend from a position separate from the optical axis in a second direction intersecting the first direction in a direction towards the optical axis,
the arm portion has a curved shape in the cross-section, and
the arm portion includes:
a first arm portion that extends from a first end portion of the first flange portion farthest from the optical axis in the second direction toward the second flange portion, and
a second arm portion that extends from a third end portion farthest from the optical axis of the second flange portion in the second direction toward the first flange portion and is connected to a second end portion of the first arm portion on an opposite side to the first end portion of the first arm portion,
the cross-section of the first arm portion has a curved shape that protrudes from the first flange portion toward the second flange portion, and
the cross-section of the second arm portion has a curved shape that protrudes from the second flange portion toward the first flange portion.

2. The vibration device according to claim 1, wherein
when a distance in the first direction from a part in the first flange portion in contact with the translucent body to a connection part of the first arm portion and the second arm portion is defined as a first distance and a total length of the arm portion in the first direction is defined as a second distance,
a ratio of the first distance to the second distance is equal to or greater than 0.05.

3. The vibration device according to claim 1, further comprising a holding member positioned outside the translucent body in the second direction and constructed to hold the connection between the translucent body and the first flange portion.

4. The vibration device according to claim 3, wherein the holding member includes a fastening portion at an end portion of the holding member farthest from the first flange portion in the first direction, the fastening portion protruding from the holding member toward the lens.

5. The vibration device according to claim 3, wherein the holding member has asymmetry with respect to the optical axis.

6. The vibration device according to claim 1, wherein a radius of curvature of the curved shape of the first arm portion is larger than a radius of curvature of the curved shape of the second arm portion.

7. The vibration device according to claim 1, wherein the arm portion extends along the optical axis.

8. The vibration device according to claim 1, wherein a thickness of the second flange portion is larger than a thickness of the first flange portion.
